(19) United States
(12) Patent Application Publication
(10) Pub. No.: US 2003/0014267 A1
(43) Pub. Date: Jan. 16, 2003

(54) System and method for optically capturing information for use in product registration

(76) Inventor: Jerlyn R. Culp, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/903,083

(22) Filed: Jul. 10, 2001

(51) Int. Cl. G06F 17/60

(52) U.S. Cl. 705/1

(57) ABSTRACT

A system and method are disclosed which enable optical capture of product registration information to aid in completion of product registrations. One embodiment provides a system for performing product registration, which comprises an optical device operable to optically capture a visual object associated with a product as digital data. The visual object includes product registration information for the product. The optical device may be an optical scanner or a digital camera, as examples. The optical device may be communicatively coupled to a first processing system, which is operable to communicate the captured product registration information to a second processing system (e.g., a vendor's product registration system) via a communication network. The product registration information may be optically captured by a user from a purchased product (e.g., at the user's home). Alternatively, the product registration information may be optically captured during a point-of-sale transaction.

### BACKGROUND

Many types of products are offered for sale that require a purchaser (or user) to complete registration for such product. It may be important for the user to complete the registration in order to be entitled to full benefits available with the product (e.g., customer support and/or warranty benefits). Also, manufacturers may desire that users register products for various reasons. As examples, a manufacturer may use product registration to track ownership of products and/or determining the warranty period for products.

Benefits associated with a product, such as a manufacturer's warranty and customer support, are often contingent on a registration being completed for such product. For instance, if a user has problems with a product shortly after purchasing it, the user's ability to obtain customer support from the manufacturer or to obtain a replacement product is often contingent upon registration of the product. Additionally, registration may be used by manufacturers in an attempt to protect against piracy or improper use of the product. Further, the registration process may be used by a manufacturer to gain not only information needed for the registration, but to also gain additional information about a user, such as an identification of items likely to be purchased by the user in the near future, listing of additional features the user would like to see added to the product, etcetera. Thus, completing the registration process may be beneficial to both a purchaser/user and a manufacturer of a product.

Typically, the registration process for a product collects various information from a user, such as user information (e.g., user's name, address, etc.) and product information (e.g., product serial number, date product was purchased, where the product was purchased, etcetera). Additionally, as described above, a manufacturer may try to gather additional user information that is not required for the product registration, such as information about the user's interests, the user's purchasing habits, etcetera.

Generally, product registration is typically performed in one of two ways. A first registration method utilizes physical media, such as a registration card, that a user completes and mails to the manufacturer. Such physical media may be included with the purchased product and it may have a serial number (or other identification) of the purchased product pre-written (e.g., stamped) on it. Alternatively, a label having the purchased product's serial number (or other identification) may be included with the product and a user may be required to attach such label to a physical media, or a user may instead be required to find the serial number (or other identification) on the product and write the serial number on the physical media. Once the user completes the information on the physical media, the user mails it to the manufacturer of the product, whereat the information is extracted from the physical media in some way and entered into the manufacturer's system.

A second registration method, which is becoming increasingly available, is online registration. Online registration may enable a user to utilize a processor-based device (e.g., a PC) to connect to a registration application and enter the required information into such application. For example, a user may access the manufacturer's website via the Internet and submit the necessary registration information to the manufacturer by completing a form available on such website.

As an example, suppose a user (or “customer”) purchases a digital camera. Using the first of the above-described registration methods, the user may complete a registration card included with the digital camera and return such registration card to the manufacturer via mail. Once the manufacturer receives the registration card, information from the card is entered into the manufacturer's system, thereby completing the product registration process. Utilizing the second of the above-described registration methods, the user may access the manufacturer's website and enter information, such as the digital camera's serial number, the user's name and address, etcetra, onto a form provided on the website, and then submit such information (e.g., by clicking a “submit” button) to complete the registration process. Once the information is submitted, it is written to the manufacturer's system, thereby completing the product registration process.

Of course, the above registration processes are not limited to use in registering digital cameras, but may be utilized in registering any type of product. Furthermore, computer software products may require such product registration, and such computer software products may automatically attempt to establish the necessary connection for performing online registration upon being installed on a user's computer.

### SUMMARY OF THE INVENTION

The present invention is directed to a system and method which enable optical capture of product registration information to aid in completion of product registrations. One embodiment provides a system for performing product registration, which comprises an optical device operable to optically capture a visual object that is associated with a product as digital data. The visual object further comprises product registration information for the product. The optical device may be communicatively coupled to a first processing system, which is operable to communicate the captured product registration information to a second processing system via a communication network.

### BRIEF DESCRIPTION OF THE DRAWING

FIG. 1 shows an exemplary environment in which various embodiments of the present invention may be implemented;

FIGS. 2A-2B show examples of embodiments of the present invention wherein a user utilizes an optical device to optically capture product registration information for a purchased product;

FIG. 3 shows an operational flow diagram illustrating an example of a registration process that may be utilized in the exemplary implementations of FIGS. 2A-2B for registering a purchased product;

FIG. 4 shows an example of an embodiment of the present invention wherein product registration information may be optically captured during a point-of-sale transaction for such product; and

FIG. 5 shows an operational flow diagram illustrating an example of a registration process that may be utilized in the exemplary implementation of FIG. 4 for registering a product at the point-of-sale of such product.

### DETAILED DESCRIPTION

Turning to FIG. 1, an exemplary environment 100 in which various embodiments of the present invention may be implemented is shown. Environment 100 includes a registrar site (e.g., a vendor or manufacturer site) comprising processing system 101, which may be communicatively coupled to data storage device 102. As described in the exemplary embodiments provided hereafter, a product may be registered with a vendor or manufacturer and such registration may be processed/recorded in such vendor's or manufacturer's processing system 101. While in certain implementations a registrant may register a product with a vendor or manufacturer, in various embodiments products may be registered with any type of registrar (and such registrar's registration process may utilize processing system 101), and therefore the present invention is not intended to be limited solely to registration of products with vendors or manufacturers but is intended to encompass registration of products with any type of registrar.

Processing system 101 may be any suitable processor-based system, such as a personal computer (PC), web server, or other computer system. Data storage device 102 may be integrated with processing system 101 or external thereto. Data storage device 102 may be any suitable data storage device, including without limitation random access memory (RAM), disk drives, floppy disks, optical discs (e.g., compact discs (CDs) and digital versatile discs (DVDs)), and other data storage devices. Processing system 101 is communicatively coupled to communication network 103, which may be any suitable communication network, such as a general purpose processor-based information network, public switched telephone network (PSTN), wireless network, local area network (LAN), wide area network (WAN), modem to modem connection, the Internet, an Intranet, an Extranet, or any combination thereof, as examples. As described in greater detail hereafter, according to various embodiments of the present invention, product registration information may be received by processing system 101 via communication network 103 and stored in data storage device 102.

Environment 100 preferably also comprises a user's home site processing system 104. Processing system 104 may be any suitable processor-based system, such as a PC, laptop, personal digital assistant (PDA), web TV configuration (e.g., including a web TV set-top box coupled to a television set), or other computer system. Processing system 104 may be communicatively coupled to optical device 105, which may be any suitable device for optically capturing visual objects as digital data, including without limitation an optical scanner, barcode scanner, optical wand, Cue Cat™ or a digital camera. As shown, processing system 104 may be communicatively coupled to communication network 103. As described in greater detail hereafter, according to one embodiment of the present invention, a user may utilize optical device 105 to optically capture product registration information (e.g., product identification information) as digital data within processing system 104, and such product registration information may be communicated from processing system 104 to a vendor's product registration system 101 via communication network 103.

Further included in environment 100 is a point-of-sale (POS) site comprising processing system 106. Processing system 106 may include any suitable processor-based system, including without limitation cash registers, PCs, or other computer systems that may be implemented at such a POS site (e.g., a consumer goods store). Processing system 106 may be communicatively coupled to optical device 107, which may be any suitable device for optically capturing visual objects as digital data, including without limitation an optical scanner (e.g., a handheld scanner or table-top scanner) operable to scan bar codes, such as universal product code (UPC) labels. Such optical scanners are commonly implemented in POS systems for optically scanning bar codes of products during a sale transaction of such products, wherein such bar codes may include information for identifying the product, its price, and possibly other information. As described in greater detail hereafter, according to one embodiment of the present invention, product registration information (e.g., product identification information) may be optically captured by optical device 107 as digital data within processing system 106 during a POS transaction, and such product registration information may be communicated from processing system 106 to a vendor's product registration system 101 via communication network 103.

In operation of at least one embodiment of the present invention, a user may purchase a product, and may then use optical device 105 to optically capture product registration information for such product. Thereafter, processing system 104 may communicate such product registration information to the vendor (or manufacturer) of such product. That is, processing system 104 may communicate such product registration information to vendor processing system 101 via communication network 103. As an example, such optical capture of registration information may be performed as part of the installation process of a computer hardware or software product. For instance, a computer hardware product may be coupled to processing system 104, and during its installation process, software may execute on processing system 104 to walk a user through the registration process, including optically scanning registration information associated with such computer hardware product. Of course, various embodiments of the present invention may be utilized to aid in acquiring product registration information not only for computer hardware and software products, but also for any other types of products for which product registration may be desirable.

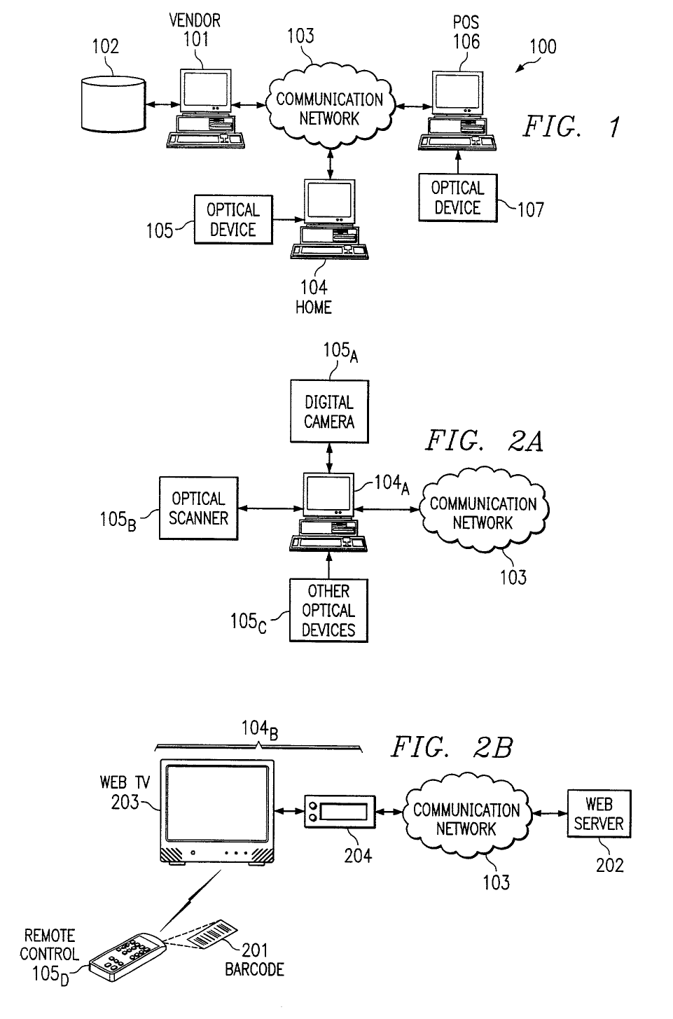

Turning now to FIGS. 2A and 2B, examples are shown of embodiments wherein a user employs an optical device to optically capture product registration information for a purchased product. As shown in the example of FIG. 2A, processing system 104 may be implemented as a computer 104_{A}, such as a PC, laptop computer, or PDA. Computer 104_{A} may be communicatively coupled to an optical device, such as digital camera 105_{A}, optical scanner 105_{B}, or any other suitable optical capture device 105_{C} capable of optically capturing visual objects as digital data. Computer 104_{A} may be communicatively coupled to communication network 103. Accordingly, a user may optically capture information from a product utilizing digital camera 105_{A}, optical scanner 105_{B}, or other optical device 105_{C}. For example, the purchased product may have included therewith a visual object that includes product registration information, such as product identification information (e.g., product serial number), which is capable of being optically captured by an optical device 105.

Examples of such a visual object include, but are not limited to, text, bar codes, and other suitable image, which may include product registration information (e.g., information identifying the product being registered). Such visual object may, for example, be included on the packaging of the product (e.g., a box in which the product is packaged), on informational sheets included with the product, and/or on the product itself. Thus, the product registration information may be optically captured by optical device 105 and represented as digital data within computer 104_{A}. The user may supplement such captured information by inputting supplemental information to computer 104_{A} (e.g., utilizing a keyboard, mouse, and/or other input device), and the product registration information may then be communicated from computer 104_{A} to a vendor's processing system (not shown in FIG. 2A) via communication network 103.

As shown in the example of FIG. 2B, processing system 104 may be implemented as Web TV configuration 104_{B}, which includes television 203 and set-top box 204, which may be communicatively coupled to communication network 103 (e.g., the world wide web) to which web server 202 is also communicatively coupled. In this example, remote control 105_{D} may comprise an optical capture device in addition to other functionality commonly included in a Web TV remote control. An example of such a remote control that comprises an optical capture device is further disclosed in co-pending and commonly assigned U.S. patent application Ser. No. 09/525,094 entitled “Scanner with Video Output” filed Mar. 14, 2000, the disclosure of which is hereby incorporated herein by reference. Thus, a user may optically capture information from a product utilizing remote control 105_{D} For instance, remote control 105_{D} may be utilized to optically scan bar code 201 that is associated with a purchased product. Remote control 105_{D} may then communicate such optically captured information via wireless transmission (e.g., infrared transmission) to Web TV configuration 104_{B}. In other implementations, various other types of optical capture devices may be utilized, including for example, an optical scanner or digital camera communicatively coupled to set-top box 204. The user may supplement such captured information by inputting such supplemental information to Web TV configuration 104_{B} (e.g., utilizing a keyboard, mouse, and/or other input device that may be coupled to set-top box 204), and the product registration information may then be communicated from Web TV configuration 104_{B} to a vendor's web server 202 via communication network 103.

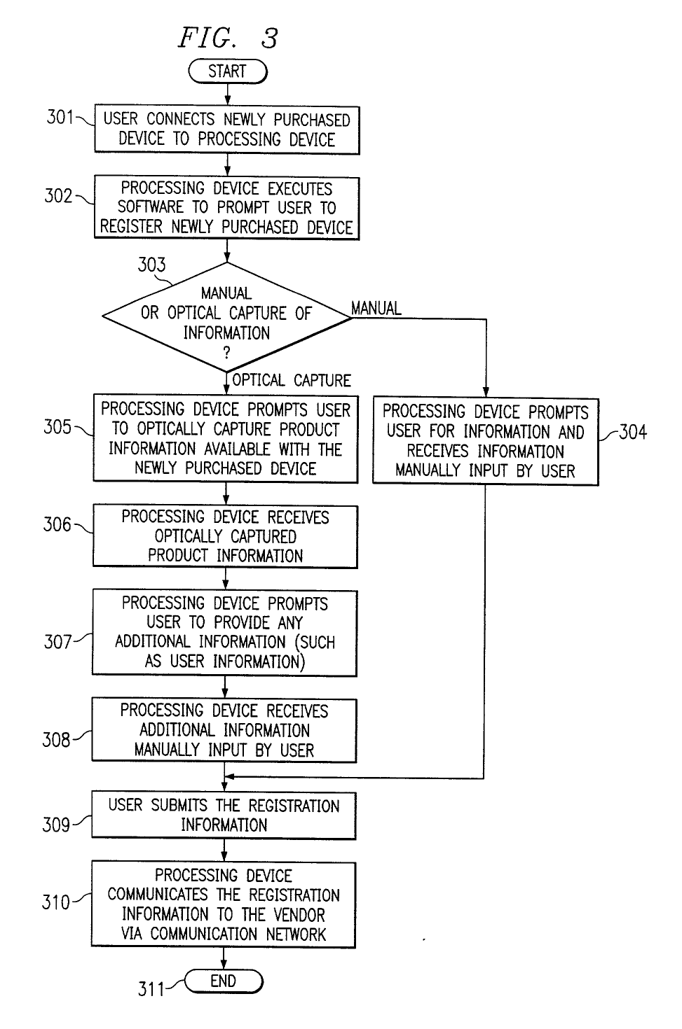

Turning now to FIG. 3, an operational flow diagram illustrating an example of a registration process that may be utilized in the exemplary implementations of FIGS. 2A-2B for registering a purchased product. In this example, a user may purchase a hardware product (e.g., a digital camera, optical scanner, printer, PC, etc.) that may be communicatively coupled to processing system 104. While a hardware product is used in this example, it should be understood that software products may be registered in a similar manner. As described further hereafter, it should also be understood that in certain embodiments a similar registration process may be performed for products incapable of being communicatively coupled to (or installed on) processing system 104.

At operational block 301 the user may couple the newly-purchased product to processing system 104. Of course, in some implementations such newly-purchased product may comprise processing system 104 itself (e.g., may be a computer system or Web TV configuration). Further, in other implementations, such newly-purchased product may comprise software, which may be installed on processing system 104 in operational block 301. Also, in other implementations, such newly-purchased product may comprise a product that is incapable of being coupled and/or installed on processing system 104. As an example, the newly-purchased product may comprise a kitchen appliance (e.g., a refrigerator, microwave, toaster, stove, etc.) that is incapable of being coupled to processing system 104.

Operational block 301 may therefore be omitted in certain implementations, and any such implementations are intended to be within the scope of the present invention.

At operational block 302, processing system 104 executes software to prompt the user to register the newly-purchased device. Such software may be installation software provided with the newly-purchased device and installed on processing system 104, for example.

Alternatively, such software may be software pre-loaded onto processing system 104. In certain embodiments, such software may be executing on a server (e.g., a web server) that is communicatively accessible by processing system 104 via communication network 103. Thus, for instance, according to certain embodiments a user may access a vendor's website, which may be executing such software. At block 303, processing system 104 may determine whether the user desires to manually input registration information or to optically capture registration information. More specifically, in certain embodiments, the software application executing on processing system 104 or on a server communicatively accessible by such processing system 104 may determine whether the user desires to optically capture registration information. For example, the software application may inform the user that if the user has access to an optical capture device, the user may optically scan product registration information associated with the purchased product, and may then inquire as to whether the user would like to perform such optical capture of product registration information.

If the user desires to manually input registration information (e.g., if the user does not have access to an optical capture device), operation proceeds to operational block 304 whereat processing system 104 prompts the user for registration information and receives registration information manually input by the user. That is, the software application may prompt the user for product registration information, which the user may manually enter (e.g., using a keyboard, mouse, or other input device) to processing system 104. Once the user inputs the registration information in block 304, operation proceeds to block 309, which is described in greater detail hereafter.

If processing system 104 determines at block 303 that the user desires to optically capture registration information, operation proceeds to block 305 whereat processing system 104 prompts the user to optically capture product information available with the newly-purchased product. That is, the software application may instruct the user to optically scan a visual object included with the purchased product, which includes product registration information. In response, the user may utilize optical capture device 105 to optically capture product information associated with the newly-purchased product. It should be understood that in certain implementations, the newly-purchased product may be optical capture device 105. Thus, in certain implementations upon a user purchasing an optical capture device 105 (e.g., optical scanner, digital camera, etc.), the user may utilize such newly-purchased optical capture device 105 to optically scan product registration information included therewith into processing system 104. Processing system 104 receives the optically captured product registration information from optical capture device 105 at block 306. That is, the captured visual object that includes product registration information is received as digital data by processing system 104. At block 307, processing system 104 may prompt the user to input any additional registration information needed, which was not included in the optically captured visual object, such as user information (e.g., the user's name, address, etc.), and at block 308 processing system 104 receives such additional information manually input by the user (e.g., using a keyboard, mouse, or other input device). Further, information from the user's system (e.g., from the processor-based system 104) may be compiled for communication to the vendor in certain embodiments. For instance, if the product being registered is a product that is to be installed on or coupled to such processor-based system 104, then information about such system may be desired for the registration process. Accordingly, such information as system identification, processor speed, disk space, memory, etcetera for the processor-based system 104 may be compiled for communication to the vendor.

At block 309, the user may submit the product registration information to the vendor (e.g., by activating a “submit” button presented by the software application). In response, processing system 104 communicates the product registration information to the vendor's processing system 101 via communication network 103 at block 310 (whereat processing system 101 may store such product registration information in data storage device 102 of FIG. 1), and the registration process is then complete at block 311.

As described above, at least one embodiment of the present invention enables a user to optically capture product registration information after the product has been purchased (e.g., at the user's home). According to other embodiments of the present invention, product registration information may be optically captured during a POS transaction in which a product is sold. For instance, referring again to the example of FIG. 1, a user may purchase a product at a POS site, whereat optical device 107 is operable to optically capture product registration information for such product. Thereafter, processing system 106 may communicate such product registration information to the vendor (or manufacturer) of such product. That is, processing system 106 may communicate such product registration information to vendor processing system 101 via communication network 103.

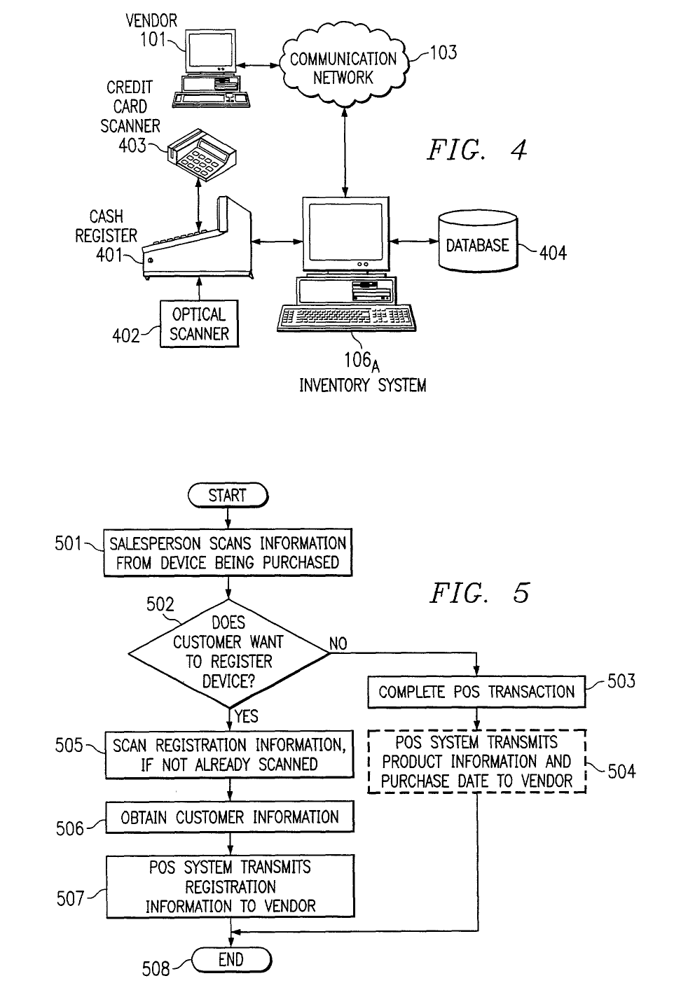

FIG. 4 shows an example of an embodiment wherein product registration information may be optically captured during a POS transaction for such product. As shown in the example of FIG. 4, point-of-sale processing system 106 may be implemented as a computer system 106_{A}, which may, for example, be the “back room” computer system (e.g., inventory system) of a store. Computer 106_{A} may be communicatively coupled to cash register 401.

Cash register 401 may be communicatively coupled to an optical device, such as optical scanner 402. Also, cash register 401 may be communicatively coupled to credit card scanner 403. As further shown, computer 106_{A} may be communicatively coupled to data storage device 404, which may be integral to computer 106_{A} or external thereto. Such an arrangement is common within point-of-sale systems. For instance, optical scanner 402 is typically used by a salesperson to optically scan a bar code of a product during a sales transaction to capture information such as identification of the product. Cash register 401 may then retrieve the appropriate price for the scanned product from computer 106_{A}. For instance, product information may be stored in data storage device 404, such as the number of each products currently in the store's inventory, the current price of each product, etcetera.

Thus, computer 106_{A} may retrieve information from data storage device 404, such as the sale price of products, to be used during the sales transaction by cash register 401. Additionally, cash register 401 may communicate the sale of a product to computer 106_{A}, and computer 106_{A} may then take such actions as updating its inventory count in data storage device 404, generating sales reports, etcetera. While an example of a typical point-of-sale system has been described above, it should be understood that various embodiments of the present invention may be implemented within any type of point-of-sale system, and therefore the present invention is not intended to be limited to the exemplary implementation of a point-of-sale system shown and described in conjunction with FIG. 4.

Also, computer 106_{A}, may be communicatively coupled to communication network 103, to which vendor's (or manufacturer's) computer system 101 may also be communicatively coupled. Accordingly, a sales clerk may utilize optical scanner 402 to optically capture information from a product during a POS transaction selling such product.

For instance, a visual object associated with the product may include product registration information, which optical scanner 402 may capture as digital data. As one example, a bar code (e.g., a UPC label) that is commonly scanned during a POS transaction may include product registration information therein. Thus, product registration information may be captured during the optical scanning of such product that is commonly performed for capturing information for completing the POS transaction. In certain implementations, product registration information may be stored in data storage device 404, and optically capturing a visual object (e.g., UPC bar code) of a product during the POS transaction may enable computer 106A to identify the product registration information from data storage device 404 for such product. Therefore, in certain embodiments, visual object captured during the POS transaction may identify a product for which registration information (such as product serial number, etcetera) is stored in computer 106A, for example, for communication to the vendor, while in other embodiments the product registration information (such as product serial number, etcetera) may be included within the visual object captured during the POS transaction and then communicated to the vendor. Alternatively, another visual object may be included with the product (which is not typically scanned in completing the POS transaction), and such other visual object may include product registration information. For instance, the sales clerk may utilize optical scanner 402 to optically scan such other visual object for capturing product registration information in addition to scanning the UPC label of such product as is typically performed for completing the POS transaction.

The sales clerk and/or customer may supplement such optically-captured information by inputting supplemental information (e.g., customer information, such as customer name, address, etc.) to cash register 401. For instance, the sales clerk may ask the customer for such supplemental information, and the sales clerk may manually input the supplemental information into cash register 401 (e.g., using a keyboard, mouse, or other input device). Alternatively, an input device (e.g., keyboard or other input device) may be available to the customer, so that the customer may manually enter such supplemental information. The product registration information (including both the optically captured information and any supplemental information manually entered) may then be communicated from cash register 401 to computer 106_{A}, which may in turn communicate such product registration information to a vendor's processing system 101 via communication network 103.

FIG. 5 shows an operational flow diagram illustrating an example of a registration process that may be utilized in the exemplary implementation of FIG. 4 for registering a product at the point-of-sale of such product. In this example, a salesperson scans information from the product being purchased at operational block 501. Such optical scanning of a product is commonly performed during a sales transaction. For instance, the UPC label (e.g., a bar code) of a product may be optically scanned by a point-of-sale system to capture information relating to the product, such as an identification of the product, the sale price, etcetera. At block 502, the salesperson determines whether the customer wants to register the product during the point-of-sale transaction. For example, the point-of-sale system may prompt the salesperson to inquire as to whether the customer desires to perform product registration. More specifically, the point-of-sale system may recognize the product as being one for which product registration may be performed during the POS transaction, and may therefore prompt the salesperson to inquire as to whether the customer desires to perform such product registration.

If it is determined at block 502 that the customer does not want to register the product, the POS transaction is completed at block 503. That is, any remaining steps required to be taken to complete the POS transaction (e.g., receiving payment from the customer, etc.) are performed at block 503. In certain embodiments, information pertaining to the purchased product may be communicated from the POS system to a vendor's (or manufacturer's) system via a communication network, at block 504. For example, identifying information of the product (e.g., the product serial number) and the purchase date may be communicated from the POS system (e.g., from computer 106_{A}) to the vendor's (or manufacturer's) registration system 101. Thus, if the user later attempts to register the product, the vendor (or manufacturer) may already possess certain information relating to the registration of the product, such as the purchase date of the product. For instance, once the vendor receives identification of the product (e.g., the product serial number) from the user, the vendor may look-up the received purchase date of the product (as well as any other information) received from the POS system. Accordingly, the vendor can verify the accuracy of registration information received from the user. Information such as the purchase date of the product may be important for determining the period during which the product is covered by warranty, as many warranty periods begin as of the date of purchase. Accordingly, receiving such product registration information from the POS system may be beneficial to a vendor.

If it is determined at block 502 that the customer does want to register the product being purchased, operation proceeds to block 505, whereat the salesperson may use optical scanner 402 to optically scan registration information, if such information is not already scanned. For instance, a bar code or other visual object comprising registration information therein may be included on the packaging of the product, and optical scanner 402 may be used to optically scan such bar code to capture the registration information included therein as digital data within the POS system (e.g., within cash register 401, which may communicate such digital data to computer 106_{A}. Such product registration information may be included within the bar code information (e.g., UPC label) that was previously captured in operational block 501, and therefore an additional scan in block 505 may be omitted in certain embodiments. Thereafter, at block 506, supplemental information (such as the customer's name, address, etc.) may be gathered from the customer and input into the POS system. In some embodiments, the salesperson may enter such information, while in other embodiments an input device may be utilized by the customer to input such information.

In certain embodiments, customer information may be gathered from credit card scanner 403 if the customer pays for the product by credit card, and/or customer information may be gathered from a check processing system (not shown in FIG. 4) if the customer pays for the product by check. For instance, such customer information as their name and address may be gathered from such credit card or check transaction. Accordingly, such information may be gathered in a manner that requires little or no additional information to be manually supplied by the customer or salesperson. Further, in certain embodiments, the credit card number, expiration date, etcetera, may be communicated to the vendor (or manufacturer) as part of the registration information, which may enable the vendor (or manufacturer) to charge for customer support, etc. later provided to the customer that is not provided free of charge (e.g., for customer support provided after the warranty period has expired). Also, in certain embodiments, further information may be gathered from the POS system and communicated to the vendor (or manufacturer) as part of the product registration information, such as information regarding purchasing patterns of the customer from that store.

At block 507, the POS system transmits the registration information to the vendor's (or manufacturer's) registration system 101 via communication network 103. That is, at block 507, computer 106A may transmit digital data representing product registration information to the vendor's (or manufacturer's) registration system 101 via communication network 103.

As described above, various embodiments enable registration of products at the POS. Certain POS systems exist in the prior art that enable a warranty (e.g., an extended warranty) to be purchased for a product during a POS transaction for such product. For example, according to one such system a cashier may use a bar code scanner to optically scan a bar code that comprises information identifying the product and its sale price. The cashier may then ask the customer if he/she would like to purchase an extended warranty on the product (which may be offered by the retailer of the product), and if the customer does want to purchase the extended warranty the cashier may input information (e.g., pressing a particular key code on the cash register's keyboard) indicating that an extended warranty is being purchased for the product. The customer may then be charged an additional fee for the extended warranty and information indicating that an extended warranty has been purchased for the product may be printed on the customer's sales receipt. The customer may later be required to present the sales receipt upon attempting to obtain service under the extended warranty. Additionally, such purchase of an extended warranty may be recorded within the retailer's system or it may be recorded within a system of a third-party provider of such extended warranty (in implementations in which a third-party, rather than the retailer itself, provides the extended warranty). While a warranty may be purchased through such systems, the product being purchased remains unregistered. That is, such systems do not actually register the product. Thus, for instance, to obtain the manufacturer's warranty on the product, the customer may still be required to register the product with the manufacturer.

Various embodiments of the present invention enable product registration information to be acquired through optically capturing visual object(s) associated with a product. Examples of such product registration information that may be included within such a visual object include, but are not limited to, product serial number, product model number, product type, date the product was created, and release date (or version) of software or firmware included within the product. Such product registration information may be easily acquired and communicated to the vendor's processing system. In some implementations, a user may later call the vendor to complete the registration process (e.g., to provide user information, etc.) and/or to receive customer support, and the vendor may already have the optically captured product registration information at the time the user calls, as opposed to the vendor requiring the user to locate and provide information such as the product serial number.

It should be understood that various embodiments of the present invention may result in a product registration process that is more convenient to a user than prior art product registration techniques, which may result in an increase in the number of product registrations completed. As described above, it may be beneficial to both the user and the vendor (manufacturer) to have such product registrations completed.

What is claimed is:

1. A system for performing product registration, said system comprising:
optical device operable to optically capture a visual object associated with a product as digital data, wherein said visual object further comprises product registration information for said product; and
said optical device communicatively coupled to a first processing system, said first processing system operable to communicate said digital data to a second processing system via a communication network.

2. The system of claim 1 wherein said visual object comprises at least one selected from the group consisting of:
text, bar code, and any type of image.

3. The system of claim 1 wherein said optical device is said product.

4. The system of claim 1 wherein said product registration information comprises:
information identifying said product.

5. The system of claim 4 wherein said information identifying said product comprises at least one of the group consisting of:
product serial number, product model number, and product name.

6. The system of claim 1 wherein said optical device comprises a device selected from the group consisting of:
optical scanner and digital camera.

7. The system of claim 1 wherein said first processing system comprises a processor-based device selected from the group consisting of:
personal computer, laptop computer, personal digital assistant, Web TV configuration, point-of-sale computer system, and any processor-based computer system capable of being communicatively coupled to said communication network.

8. The system of claim 1 wherein said second processing system is a registrar's product registration system.

9. The system of claim 1 wherein said second processing system comprises a processor-based device selected from the group consisting of:
personal computer, laptop computer, web server, and any processor-based computer system capable of being communicatively coupled to said communication network

10. The system of claim 1 wherein said first processing system is operable to receive further product registration information.

11. The system of claim 10 wherein said first processing system is operable to receive said further product registration information via input from a user.

12. The system of claim 1 wherein said optical device is within a point-of-sale system.

13. The system of claim 12 wherein said visual object is optically captured during a sales transaction of said product.

14. A method for performing product registration, said method comprising the steps of:
optically capturing a visual object associated with a product as digital data, wherein said visual object comprises product registration information for said product; and
communicating said digital data to a registrar processing system via a communication network.

15. The method of claim 14 wherein said visual object comprises at least one selected from the group consisting of:
text, bar code, and any type of image.

16. The method of claim 14 wherein said product is an optical device, further comprising the step of
utilizing said product to perform said optically capturing step.

17. The method of claim 14 wherein said product registration information comprises:
information identifying said product.

18. The method of claim 14 wherein an optical capture device is utilized to perform said optically capture step, further comprising the step of:
said optical capture device communicating said digital data to a first processing system.

19. The method of claim 18 wherein said first processing system performs said step of communicating said digital data to a registrar processing system.

20. The method of claim 18 wherein said optical capture device is a device selected from the group consisting of:
optical scanner and digital camera.

21. The method of claim 18 further comprising the steps of:
receiving at said first processing system further product registration information.

22. The method of claim 21 wherein said first processing system receives said further product registration information via input from a user.

23. The method of claim 21 wherein said further product registration information includes user information.

24. The method of claim 14 wherein said optically capturing step is performed during a sales transaction of said product.

25. The method of claim 24 wherein said optically capturing step is performed by an optical capture device within a point-of-sale system.

26. The method of claim 24 further comprising the step of:
supplementing said product registration information with information acquired during said sales transaction.

27. The method of claim 26 wherein said information acquired during said sales transaction includes information acquired from a credit card transaction.

28. A product registration system comprising:
means for optically capturing a visual object associated with a product as digital data, wherein said visual object comprises product registration information for said product; and
means for communicating said digital data to a processing system via a communication network.

29. The product registration system of claim 28 wherein said processing system is a registrar product registration system.

30. The product registration system of claim 28 wherein said product registration information comprises:
information identifying said product.
